(19) United States
(12) Patent Application Publication
(10) Pub. No.: US 2002/0121033 A1
(43) Pub. Date: Sep. 5, 2002

(54) Hand-held sign

(76) Inventors: Peter S. Hildyard, Salt Lake City, UT (US); Sandy E. Tiemann, Salt Lake City, UT (US)

Correspondence Address: BRIAN C. TRASK, 3601 EAST HERMES DRIVE, SALT LAKE CITY, UT, 84124, US

(21) Appl. No.: 10/086,310

(22) Filed: Mar. 1, 2002

Related U.S. Application Data
(60) Provisional application No. 60/272,547, filed on Mar. 1, 2001.

(51) Int. Cl. G09F 21/02; G09F 7/02

(52) U.S. Cl. 40/586; 40/611

(57) ABSTRACT

A hand-held sign with a handle having a portion forcibly insertable inside structure spacing apart opposite sides of a sign board. The handle may provide positive retaining structure to resist decoupling of the handle and sign board, or may be attached through a friction fit. Preferred handle embodiments provide a plurality of tines which are inserted into channel structure of a sign board. Preferred sign boards display a patriotic graphic on one face, and a suggested ranking, or score, on the opposite face.

### RELATED APPLICATIONS

This application claims the benefit under 35 U.S.C. 119(e) of the filing date of Provisional Application Serial No. 60/272,547, filed Mar. 1, 2001, for “HAND-HELD SIGN”.

### BACKGROUND OF THE INVENTION

1. Field of the Invention

This invention relates to signs. It is particularly directed to a two-sided, hand-held sign. Certain preferred embodiments of the invention are directed to spectator cheering, and have patriotic and suggested scoring marks on opposite sides of the sign board.

2. State of the Art

Signs having a support (e.g. a handle, stick, or post), capable of transporting, displaying, and waving the sign by hand, are well known. Sign boards made from material that is light in weight, and sufficiently rigid to display by attachment of the sign board to a short support (e.g. a stick, or post), are also known. Methods of attaching the sign support to the sign board have been developed, and include adhesives, mechanical fasteners, and various arrangements to secure a sign board sandwiched between two or more supports. A support can even be passed through transversely oriented slots through the sign board effectively to weave a retaining interference between the support and the sign board. Such fastening methods undesirably require a support member to cover at least a portion of at least one face of the sign board. Additionally, fasteners typically require tools for their assembly, and further may interrupt or detract from the graphics carried by the sign.

An example of a prior art sign support is formed from a length of a board having a rectangular cross-section. A portion of the board can be attached to one face of the sign board by an adhesive, or some other known attachment method. A problem attendant to such a support is that the board will unavoidably obscure at least a portion of one face of the sign board. The obstructive effect can be mitigated, but requires painting the board to match the graphics covered by the attaching portion. Matching the board to the sign graphics can be tiresome, or difficult to accomplish. An adhesive attachment requires a certain amount of time to cure, and may not be a suitable attachment method for assembly of the sign and handle for immediate use in the field. A quick-connecting, tool-free attachment of a handle to a hand-holdable sign, and which does not obscure the graphics on either side of the sign, would be a desirable improvement to hand-held signs.

### BRIEF SUMMARY OF THE INVENTION

The present invention provides an apparatus for a hand-held sign with two opposed display faces. A sign according to the invention includes a sign board having first and second sign faces spaced apart by structure forming internal channels, and a handle having attach structure adapted for insertion into at least one of the internal channels. The attach structure can be a plurality of tines having a thickness sized for forced insertion between the faces of the sign board. Certain embodiments further include a positive retaining structure adapted to resist decoupling of a handle from a sign board assembled thereon.

Exemplary attach structure includes a plurality of tines, at least one of the tines being arranged in a nonlinear shape along an inserted portion, with the nonlinear shape providing a biased engagement between edges of the tine and internal structure of the sign board. The engagement between a sign and handle can be a friction fit between a tine and structure of a channel. Certain desirable handles are formed from a material having resilience to permit a nonlinear shape in a tine to deflect sufficiently to enable insertion of the tine into a channel, whereby to establish a self-biased, friction interference fit with an interior surface of the channel. Sign boards can also include a plurality of indicia disposed on one of the faces, with the indicia being configured and arranged to indicate a plurality of locations where a tine may be inserted.

Certain exemplary signs provide a graphic evoking patriotic spirit on one face; and a graphic suggesting a ranking on the opposite face. Other exemplary signs (e.g. for political rallies) provide a graphic evidencing an affiliation (such as a State or party) on one side; and a graphic suggesting an individual on the other side.

These features, advantages, and alternative aspects of the present invention will be apparent to those skilled in the art from a consideration of the following detailed description taken in combination with the accompanying drawings.

### BRIEF DESCRIPTION OF THE SEVERAL VIEWS OF THE DRAWINGS

In the drawings, which illustrate what are currently considered to be the best modes for carrying out the invention:

FIG. 1 is an assembled sign including a support handle with tines inserted into a sign board;

FIG. 2 is a view in perspective of an edge portion of the sign board of FIG. 1 and a plurality of handle tines prior to their insertion into the sign board;

FIG. 3 is a second embodiment of a handle illustrating keeper structure to retain a sign board thereon;

FIG. 4 is a third embodiment of a handle, having nonlinear tines;

FIG. 5 illustrates an alternate positive retaining structure on a tine end.

### DETAILED DESCRIPTION OF THE INVENTION

Reference will now be made to the drawings in which the various elements of the invention will be given numerical designations and in which the invention will be discussed so as to enable one skilled in the art to make and use the invention. It is to be understood that the following description is only exemplary of the principles of the present invention, and should not be viewed as narrowing the claims which follow.

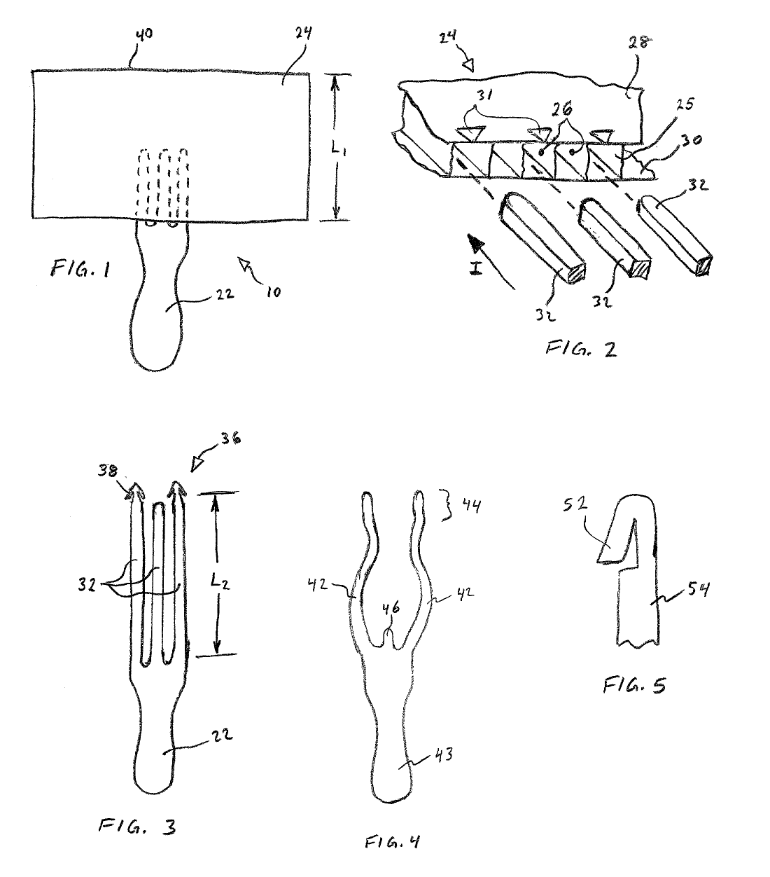

The present invention provides an apparatus for a hand-held sign, generally indicated at 10 in FIG. 1. The sign 10 includes a handle 22 for hand-held operation of a sign board 24. Sign board 24 is characterized by internal structure 25 forming internal channels 26, as illustrated in FIG. 2. Sign boards 24 may be formed from any suitable material, including without limitation corrugated cardboard and the like. Use of coated papers, or plastic materials, increases a sign's resistance to damage from moisture, and may improve rigidity of the sign board to resist folding. An exemplary material for a sign board 24 is sold under the trade name “Corex” and is made from fluted polyethylene. Channels 26 may be of any cross-sectional shape, although approximately rectangular is most common. A typical sign board 24 may be printed upon an exterior visible portion of one or both of sign faces 28 and 30.

A sign 10 advantageously includes a handle 22 to support the sign board 24 and to facilitate rotating the sign 10 to reveal one face 28 and then the other face 30 for display toward a fixed location. Handles 22 may be made from any material capable of supporting a sign board 24. It is currently preferred to manufacture handles from one of a variety of plastic materials, although wood and metal are also workable. Handles can be injection molded, stamped, or even water-jet or laser cut from flat stock. Simple, low cost manufacturing methods are workable to form handles.

A handle 22 is typically affixed to a sign board 24 by inserting a plurality of tines 32 into corresponding channels 26, as indicated by arrow I. A handle 22 inserted between the faces 28 and 30 advantageously holds the sign for hand manipulation, or waving, without obscuring the sign graphics. One or more indicia 31 may be printed on one or both faces 28 and 30 to assist in assembly of tines 32 into appropriate channels 26. A handle may have any number of tines 32, although two or more are currently preferred to provide rotational control of an assembled sign 10. Tines 32 may be in partial depth engagement, as illustrated in FIG. 1. Alternative embodiments may have one or more tines 32 in full depth penetration through a sign board 24. An example of a handle capable of full depth penetration is illustrated by FIGS. 1 and 3, where L1 is shorter than L2.

It is within contemplation for keeper structure to be incorporated into a handle 22 to prevent undesired detachment of a sign board 24. One embodiment of keeper structure which may be carried by one or more tines 32 is illustrated generally at 36 in FIG. 3. One or more of prongs 38, or other structure, may be arranged to collapse and pass through a channel 26, and then expand to prevent withdrawal of the tine 32 by creating a structural interference with channel structure 25, or either or both of faces 28 and 30. A single prong 38 may be provided on an end of a tine 32 to face in a single direction, or may face in both directions, as illustrated.

Keeper structure 36 may also be adapted to resist withdrawal of a tine 32 without requiring the tine to protrude from the top 40 of a sign 10. One example of such keeper structure 36 may be arranged to increase the friction fit of a tine 32 in a channel 26, whereby to resist withdrawal to the tine 32. A barb type of structure is an example of such keeper structure. Barb structure within contemplation would collapse transversely to a tine axis to enter a channel 26, but provide a self-bias to press a tip into engagement with divider structure 25. Friction between the tip and divider 25 would increase the resistance force as a handle 22 is displaced away from a sign board 24.

An alternate positive retaining or keeper structure is illustrated in FIG. 5, as a retractable barb 52 carried on a distal end of tine 54. Barb 52 retracts toward a centerline of tine 52 during insertion of a tine 52 into a sign board 24, and is self-biased to expand upon protruding through the top of a sign board 24. Expanded barb 52 then protrudes to create a structural interference fit with web structure 25 at the top edge of a sign board, resisting subsequent removal of a handle 22 from a sign board 24.

It is also within contemplation that the tines 32 are maintained in engagement with a sign board 24 simply by way of a friction fit within one or more of channels 26. One way to create a friction fit between one or more tines 42 and their receiving channels 26 is illustrated in FIG. 4, where tines 42 of handle 43 are nonlinear. The tines 42 are formed with a waviness along their length, which is straightened out as each tine 42 is inserted into reception in a channel 26. On assembly inside a sign board 24, the edges of tines 42 are then biased into a friction engagement with partition structure 25. Of course, in such an embodiment, tines 42 desirably are made from a material having a resilience to provide a bias force generated by the displaced wavy tine portions. In other embodiments having a friction fit, the material forming a sign board 24 may itself supply sufficient bias force to an over-size tine 32, 42, or 46 inserted into engagement in a channel 26.

In certain embodiments, tines 42 may be rather long and flexible, so indicia 31 may be helpful to locate correct channels 26 in which to insert a tine end. An end portion 44 of each tine 42 may be substantially straight, as illustrated, to assist in its entry to a channel 26. Handle 43 also illustrates an optional third tine 46, which may carry additional positive retaining structure, such as barb structure, or structure to create an additional interference with structure of signboard 24. Long and flexible tines are best inserted into a sign board 24 by starting the ends 44 into engagement with the correct channels 26, then grasping the tines 42 near the entrance of channels 26, and partially rotating, or wiggling, the handle about an axis, vertical to faces 28 and 30, located near the edge of the sign board 24. During each partial rotation, alternating tines 42 may preferentially be advanced into the signboard 24 by a short distance.

While a sign according to the invention may have many uses, it is particularly useful for manipulating a sign 10 having two distinct and different sides 28, 30. One example of such a sign 10 includes a sign having a country's flag printed on one side 28, and a numeral or exclamation printed on the opposing side 30. A spectator may cheer for a contestant by alternately showing the flag side, and for example, an opposing side depicting the number 10 as a suggested score from one or more judges. A second exemplary sign 10 may be used as a political tool. In one circumstance for political use, a sign 10 may carry a State name on one side, and a candidate's name on the other.

A sign 10 according to the instant invention may be assembled at the location of the use of the sign without requiring the use of any tools, mechanical fasteners, or adhesives. This assembly feature allows transport of the signs 10 in a reduced volume, and reduces risk of damage to the signs and handles before they are used. Signs 10 according to the instant invention may conveniently be packaged with a detached handle 22 in a clear plastic wrap. Such packaging provides for efficient transportation of signs 10 in a reduced volume, and also provides a convenient sale display. Signs 10 may then be assembled by a consumer subsequent to a sale, or upon arrival at the site of intended use.

While the invention has been described in particular with reference to certain illustrated embodiments, such is not intended to limit the scope of the invention. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A hand-held sign, comprising:
a sign board having first and second sign faces spaced apart by structure forming internal channels; and
a handle having attach structure adapted for insertion into at least one of said internal channels.

2. A sign according to claim 1, said attach structure comprising a plurality of tines having a thickness sized for forced insertion between said faces.

3. A sign according to claim 2, said attach structure further comprising a positive retaining structure adapted to resist decoupling of a handle from a sign board assembled thereon.

4. A sign according to claim 2, said attach structure comprising a plurality of tines, at least one of said tines being arranged in a nonlinear shape along an inserted portion, said nonlinear shape providing a biased engagement between edges of said tine and internal structure of said sign board.

5. A sign according to claim 4, said engagement comprising a friction fit between a said tine and structure of a said channel.

6. A sign according to claim 4, said handle being formed from a material having resilience to permit a nonlinear shape in a said tine to deflect sufficiently to enable insertion of said tine into a said channel, whereby to establish a self-biased, friction interference fit with an interior surface of said channel.

7. A sign according to claim 4, said sign board further comprising:
a plurality of indicia disposed on one of said faces, said indicia being configured and arranged to indicate a plurality of locations where a tine may be inserted.

8. A sign according to claim 1, wherein:
said first face comprises a graphic evoking patriotic spirit; and
said second face comprises a graphic suggesting a ranking.

9. A sign according to claim 1, wherein:
said first face comprises a graphic evidencing an affiliation; and
said second face comprises a graphic suggesting an individual.

10. An improved sign of the type that is hand-held, and rotatable to reveal opposite sign faces to a fixed location, the improvement comprising:
a sign board comprising first and second sign faces spaced apart in a thickness direction by dividing structure, said dividing structure also forming a plurality of channels; and
a handle comprising a plurality of tines adapted for engagement inside a plurality of said channels; wherein:
said tines of said handle are forced into engagement inside said channels to assemble said sign.

11. The sign of claim 10, further comprising a positive retaining structure on a distal end of at least one tine.

12. The sign of claim 10, said tines being configured and arranged to form a self-biased friction engagement with said dividing structure of said sign board.

13. The sign of claim 10, said dividing structure being configured and arranged to form a self-biased friction engagement with said tines.

14. The sign of claim 10, in combination with a clear film packaging material configured as a sack, wherein said handle and said sign board are enclosed in a disassembled condition within said sack.

15. The combination of claim 14, wherein:
said first face comprises a graphic evoking patriotic spirit; and
said second face comprises a graphic suggesting a ranking.

16. The combination of claim 14, wherein:
said first face comprises a graphic evidencing an affiliation; and
said second face comprises a graphic suggesting an individual.
